(19) United States
(12) Patent Application Publication
(10) Pub. No.: US 2010/0143666 A1
(43) Pub. Date: Jun. 10, 2010

(54) REDOX ACTIVATED PATTERNING

(75) Inventors: Chad A. Mirkin, Wilmette, IL (US); Adam B. Braunschweig, Evanston, IL (US); Andrew J. Senesi, Chicago, IL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: NORTHWESTERN UNIVERSITY, Evanston, IL (US)

(21) Appl. No.: 12/623,286

(22) Filed: Nov. 20, 2009

Related U.S. Application Data
(60) Provisional application No. 61/116,485, filed on Nov. 20, 2008.
(60) Provisional application No. 61/167,852, filed on Apr. 8, 2009.

(51) Int. Cl. B41M 5/40; B05D 5/00; B05C 11/00

(52) U.S. Cl. 428/195.1; 427/256; 427/287

(57) ABSTRACT

A method of forming a target pattern using a redox activated surface is disclosed. The method includes patterning a redox agent on a template layer formed on a substrate, the template layer having a first oxidation state, wherein upon contact with the redox agent, the contacted portion of the template layer changes to a second oxidation state different than the first oxidation state, and a template pattern is formed from the portion of the template layer having either the first oxidation state or the second oxidation state, and exposing the substrate having the template pattern to a target material, wherein the target material selectively binds to the template pattern to form a target pattern.

### CROSS-REFERENCE TO RELATED APPLICATIONS

Priority to U.S. Patent Provisional Application No. 61/116,485, filed Nov. 20, 2008, and U.S. Patent Provisional Application No. 61/167,852, filed Apr. 8, 2009, the complete disclosures of which are incorporated here in their entirety, is claimed.

### STATEMENT OF GOVERNMENTAL INTEREST

This invention was made with government support under grant FA9550-08-1-0124 awarded by the Air Force Office of Scientific Research and under grant CHE-0723542 awarded by the National Science Foundation. The government has certain rights in the invention.

### BACKGROUND

1. Field of the Invention

The invention is directed to, among other things, a patterning method, and more particularly, to a patterning method using redox-activated surfaces, and also to related methods of making and using, articles, and kits.

2. Brief Description of Related Technology

The localized deposition of biological molecules is increasingly employed in materials application, diagnostic screening, and genetic assays. Conventional, commercially available methods for generating DNA microarrays are limited to features size of about 1 μm for the direct synthesis of oligonucleotides of up to about 60 basepairs (bp) on a surface, or about 50 μm for oligonucleotides or proteins spotted on surfaces. Consequently, new lithographic methods capable of patterning biological molecules with sub-micrometer resolution are necessary.

Contact printing, dip-pen nanolithography (DPN), and polymer-pen lithography (PPL) have emerged as powerful tools for patterning surfaces on the submicrometer length scale because they can be used to transfer molecules directly to a surface rather than use energy to activate a surface in an indirect manner. The direct transfer of molecules has several advantages over photolithography and indirect scanning probe methods, including, for example, potentially reduced costs and time, and the ability to pattern organic and biological molecules. However, each of the printing methods is limited by the need to optimize deposition conditions for each new ink.

Microcontact printing is a form of soft lithography that uses an elastomeric stamp, typically poly(dimethylsiloxane) (PDMS), to directly transport materials to a surface of interest. The stamp can be used to pattern proteins, DNA, cells, alkanethiols, silanes, colloids, and salts on a variety of flat and curved surfaces. However, microcontact printing is problematic in that it is limited to printing only the pattern predetermined by the stamp. Additionally, the mechanical properties of the elastomer limit design flexibility, and the fabrication of features smaller than 150 nm is challenging.

DPN, the highest resolution technique of the aforementioned methods, involves the direct transfer of an ink from, for example, a coated atomic force microscopy (AFM) tip to a substrate. In at least some embodiments, the method utilizes a water meniscus that can form between the tip and substrate as a conduit to facilitate material (ink) transport. DPN can be performed using, for example, as many as 55,000 pens in a 1 cm² cantilever array. DPN has been used to form patterns of, for example, alkanethiols, oligonucleotides, proteins, and viruses.

PPL combines advantages of DPN and microcontact printing to form patterns spanning the sub-100 nm to many micron length scale using, for example, a computer controlled cantilever free array of elastomeric tips. PPL can utilize, for example, as many as 11×10⁶ pens in a three inch wafer to pattern over square centimeter areas with sub-100 nm resolution. DPN and PPL, however, can be limited in some embodiments by the difficulty in transporting high molecular weight species or molecules with poor aqueous solubility through the meniscus to the surface, and the need to individually optimize the transport rates and tip inking methods for each molecule.

An alternative patterning strategy includes the development of an electrochemically addressable surface that can be switched from inactive to active states, whereby patterning is achieved by selective reaction when only one of the two oxidation states exists. Yousaf et al. have developed ways of using electroactive and photoprotected quinones with alkanethiols adsorbed on gold to create surfaces that can be switched between inactive and active states using Diels-Alder or nitroxamine addition reactions with cyclopentadiene or nitroxamine-containing reagents. This technique, however, is limited, by lengthy synthesis of the photolabile protected quinine, the requirement of a photomask, which increases complexity and limits resolution, and the reliance on a Diels-Alder or nitroxamine reaction for surface immobilization, which necessitates labeling the target.

### SUMMARY

In accordance with an embodiment of the disclosure, a method of forming a target pattern includes patterning a redox agent on a template layer formed on a substrate, the template layer having a first oxidation state, wherein upon contact with the redox agent, the contacted portion of the template layer changes to a second oxidation state different than the first oxidation state, and a template pattern is formed from the portion of the template layer having either the first oxidation state or the second oxidation state, and exposing the substrate having the template pattern to a target material, wherein the target material selectively binds to the template pattern to form a target pattern.

In accordance with another embodiment of the disclosure, a method of forming a metal structure includes patterning a redox agent on a template layer formed on a substrate, the template layer having a first oxidation state, the redox agent adapted to change the oxidation state of a portion of the template layer in contact with the redox agent to a second oxidation state different from the first oxidation state, wherein a template pattern is formed from the portion of the template layer having either the first or second oxidation state; and exposing the template pattern to a metal containing compound or metal ion, the metal containing compound or metal ion being reduced by the template pattern to form a metal structure disposed on the template pattern.

In accordance with yet another embodiment of the disclosure, a method of forming a metal structure includes patterning a metal containing compound or metal ion on a template layer having a first oxidation state, the template layer adapted to reduce the metal containing compound or metal ion when in contact with the metal containing compound or metal ion, thereby forming a metal structure on the template layer.

In accordance with still another embodiment of the disclosure, a template pattern assembly includes a substrate having a template layer, a redox agent disposed on the template layer and adapted, upon contact with the template layer, to transform the contacted portion of the template layer to a second oxidation state, wherein the portion of the template layer having either the first or the second oxidation state defines a template pattern, and a target pattern formed by a target material bound to the template pattern.

In accordance with another embodiment of the disclosure, a kit for forming a template pattern includes a substrate comprising a template layer having a first oxidation state, a redox agent, a tip for patterning the redox agent on the template layer, wherein upon contact with the redox agent, the contacted portion of the template layer changes from the first oxidation state to the second oxidation state, different than the first oxidation state to form a template pattern, the template pattern being formed from the portion of the template layer having either the first oxidation state or the second oxidation state, and instructions for forming the target pattern.

### BRIEF SUMMARY OF THE DRAWINGS

FIG. 1 is a schematic representation of a method of patterning in accordance with an embodiment of the disclosure;

FIG. 2 is a schematic representation of a method of patterning in accordance with an embodiment of the disclosure, showing the reversible and site selective oxidation and reduction of quinone functionalized surfaces, and subsequent molecular immobilization by Michael addition and Diels-Alder cycloaddition;

FIG. 3 is a variable-scan cyclic voltammogram of a thiol-modified quinones as a self-assembled monolayer (SAM) on a gold surface. The two peaks indicate that the redox chemistry of the immobilized quinones is reversible, and the linear relationship between current (I) and scan rate confirms that the quinones are surface bound;

FIG. 4 is a cyclic voltammogram of the quinone-SAM in the presence of propyl amine at 1 min intervals. The increase in the peak current of the peak at −0.2 V and decrease in current of the peak at 0.25 V indicates that the Michael Addition proceeds successfully.

FIG. 5 is an X-ray photoelectron spectroscopy (XPS) spectra of (A) a bare Si/SiO₂ wafer and (B) a quinone functionalized Si/SiO₂ wafer (the spectrum being offset by 1000 counts). The emergence of the nitrogen peak and the increase in intensity of the carbon peak indicate that the silane modification with aminopropyl trimethoxysilane occurred successfully;

FIG. 5C is an ATR-FTIR spectrum of quinone monolayers on a Si/SiO₂ substrate, using a bare Si/SiO₂ wafer as a background. The peaks at 2849 cm⁻¹ (CH asymmetric stretch) and 2918 cm⁻¹ (CH asymmetric stretch) indicate the presence of aliphatic chains on the surface, and the peak at 2970 cm⁻¹ (alkene CH stretch) indicates the presence of a quinone moiety on the surface;

FIG. 5D is a Raman spectrum of a benzoquinone modified Si/SiO₂ surface. Excitation was induced with a 633 nm laser. Peaks at 1407, 1424, and 1480 cm⁻¹ correspond to aliphatic C—H stretches. Peaks at 1535, 1576, and 1620 cm⁻² correspond to quinone moieties. The peak at 1576 cm⁻¹ corresponds to monoamino benzoquinone, and the peak at 1620 cm⁻¹ corresponds to diamino quinone;

FIG. 6 is a graph of contact angles showing the reproducible chemical switching capability of the quinone surface. The left insert image is of benzoquinone and the right insert image is of hydroquinone. Reduction of the surface to the hydroquinone form was induced by immersing the surface in a 5 mM aqueous solution of sodium ascorbate. The surface was oxidized by immersion in a 5 mM aqueous solution of CAN;

FIG. 7A is a fluorescence image and corresponding fluorescence intensity line scan of a 3′ Cy3-DNA-NH₂ 5′ target patterned using a method in accordance with an embodiment of the disclosure;

FIG. 7B is a fluorescence image and corresponding fluorescence intensity line scan of a protein target patterned using a method in accordance with an embodiment of the disclosure;

FIG. 8A is a schematic representation of a method of patterning in accordance with an embodiment of the disclosure, using DPN to pattern the redox agent;

FIG. 8B is a fluorescence image and a corresponding fluorescent intensity line scan of a Cy3 labeled animated DNA target pattern formed by a method in accordance with an embodiment of the disclosure;

FIG. 8C is a fluorescence image and a corresponding fluorescent intensity line scan of a Alexa Fluor 549 (AF549) labeled CTβ protein target pattern formed by a method in accordance with an embodiment of the disclosure;

FIG. 9A is a fluorescence image and corresponding fluorescent line intensity scan of a target pattern formed by a method in accordance with an embodiment of the disclosure using DPN to deposit the redox agent and illustrating that increase in feature size of the target pattern resulting from increasing dwell time during DPN deposition of the redox agent;

FIG. 9B is an atomic force microscopy topographical image of an oligonucleotide target pattern formed by a method in accordance with an embodiment of the disclosure using DPN to deposit the redox agent and illustrating the ability to increase feature size of the target pattern (350, 450, 500, 650, 740, 800, and 830 nm, from left to right) during deposition of the redox agent by increasing dwell time (0.01, 0.05, 0.1, 0.5, 1, 5, and 10 seconds, from left to right);

FIG. 9C is a graph of dwell time verses feature area for the pattern of FIG. 9B;

FIG. 10A is a schematic representation of a method of patterning in accordance with an embodiment of the disclosure using microcontact printing with a positive stamp to deposit the redox agent;

FIG. 10B is a fluorescence image of an NH₂ modified DNA target pattern formed by the method of FIG. 10A;

FIG. 10C is a fluorescence image of a CP modified DNA target pattern formed by the method of FIG. 10A;

FIG. 11A is a schematic representation of a method of patterning in accordance with an embodiment of the disclosure using microcontact printing with a negative stamp to deposit the redox agent;

FIG. 11B is a fluorescence image of an NH₂ modified DNA target pattern formed by the method of FIG. 11A;

FIG. 11C is a fluorescence image of a CP modified DNA target pattern formed by the method of FIG. 11A;

FIG. 12A is a schematic representation of a method of patterning in accordance with an embodiment of the disclosure using microfluidic patterning with a positive stamp to deposit the redox agent;

FIG. 12B is a fluorescence image of an NH₂ modified DNA target pattern formed by the method of FIG. 12A;

FIG. 13A is a schematic representation of a method of patterning in accordance with an embodiment of the disclosure using microfluidic patterning with a negative stamp to deposit the redox agent;

FIG. 13B is a fluorescence image of an NH₂ modified DNA target pattern formed by the method of FIG. 13A;

FIG. 14A is schematic representation of a method of patterning in accordance with an embodiment of the disclosure using polymer pen lithography to deposit the redox agent;

FIG. 14B is a fluorescence image of a Cy3 labeled DNA target pattern formed by the method of FIG. 14A using polymer pen lithography with a one second contact time and showing force dependence with relative piezo extensions of 0, 2, 2, 4, 4, 6, 6, 8, 8, 10, and 10V;

FIG. 14C is a graph of feature edge length verses relative piezo extension for the pattern of FIG. 14B;

FIG. 15A is a fluorescence image of a Cy3 labeled target pattern formed by a method in accordance with an embodiment of the disclosure using polymer pen lithography to deposit the redox agent and PEG as an ink carrier for the redox agent;

FIG. 15B is a fluorescence image of a TAMRA labeled target pattern formed by a method in accordance with an embodiment of the disclosure using polymer pen lithography to deposit the redox agent and PEG as an ink carrier for the redox agent;

FIG. 16A is a schematic representation of a method of Cp phophoramidite synthesis and DNA conjugation;

FIG. 16B is a MALDI-MS image showing a peak at 107030 m/z, which is consistent with the calculated molecular weight of the oligonucleotide;

FIG. 16C a graph showing RP-HPLC traces before and after Cp modification showing an increase in retention time for the Cp modified oligonucleotide;

FIG. 17 is a schematic showing a method of forming a metal structure using direct and indirect methods in accordance with an embodiment of the disclosure;

FIG. 18A is a time of flight secondary ion mass spectrometry image (TOF-SIMS) and corresponding graph (19B) of a silver square formed by a method in accordance with an embodiment of the disclosure using an indirect method using DPN to deposit the redox agent, palmitylascorbic acid (PAA);

FIG. 18C is a scanning electron microscopy (SEM) image of the silver square of FIG. 18A;

FIG. 19A is a TOF-SIMS image of silver squares formed by a direct write method in accordance with an embodiment of the disclosure;

FIG. 19B is an SEM image of silver lines formed by a direct write method in accordance with an embodiment of the disclosure;

FIG. 20A is a XPS image of silver formed on to a hydroquinone surface by a method in accordance with an embodiment of the disclosure. The two lines indicate the presence of two electronic states of the silver on the surface, Ag(0) and Ag(I), indicating that the Ag(I) ions delivered to the surface are indeed reduced by the surface;

FIG. 20B is an XPS image of silver formed onto a hydroquinone surface by a method in accordance with an embodiment of the disclosure after exposure to AgNO₃. The lines indicate the presence of different states of carbon after exposure to the AgNO₃. The presence of a C═O peak indicates that the quinones are oxidized upon exposure to the Ag(I);

FIG. 20C is an XPS image of the template layer/template pattern surface of FIG. 20B before exposure to AgNO₃, demonstrating that the carbon prior to delivery of the Ag(I) to the surface existed in the reduced from, and no C═O is present;

FIG. 21A is an XPS image of gold and palladium formed onto a hydroquinone surface on a Si/SiOₓ substrate by a method in accordance with an embodiment of the disclosure;

FIG. 21B is an XPS image of palladium formed onto a hydroquinone surface on a gold substrate by a method in accordance with an embodiment of the disclosure; and

FIG. 22 is an optical microscopy image of an F-type tip array (A) prior to inking with the redox agent, CAN, and (B) after inking with CAN, showing an even coating.

### DETAILED DESCRIPTION

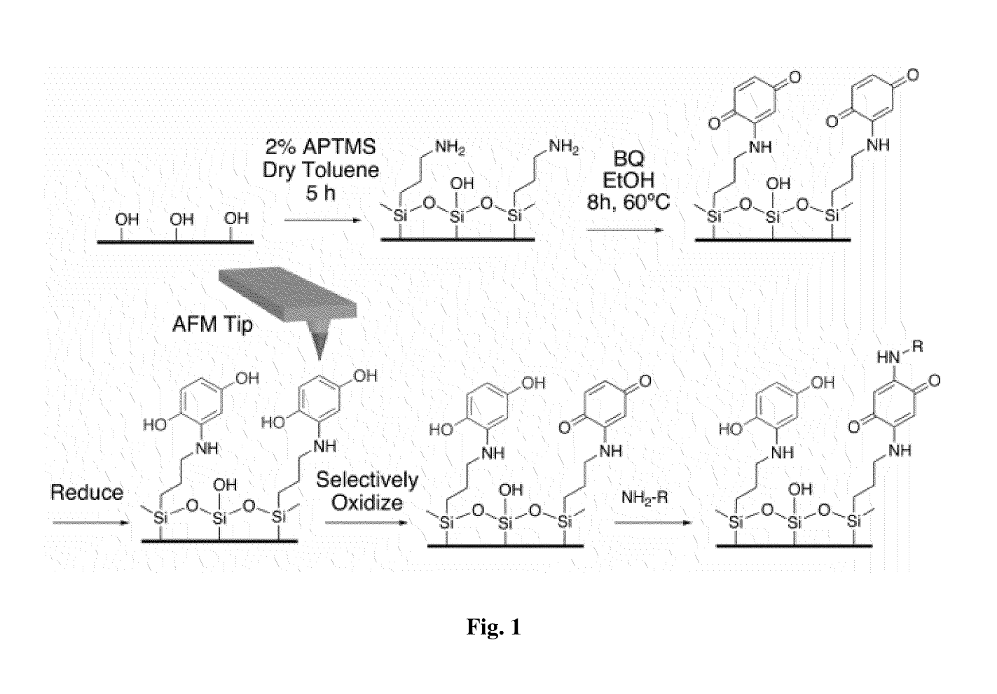

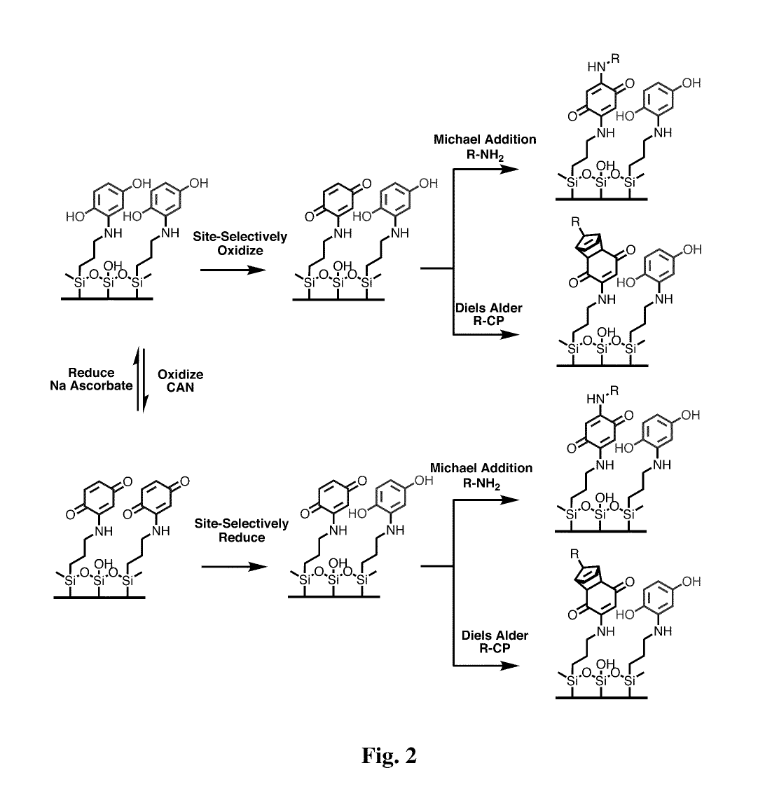

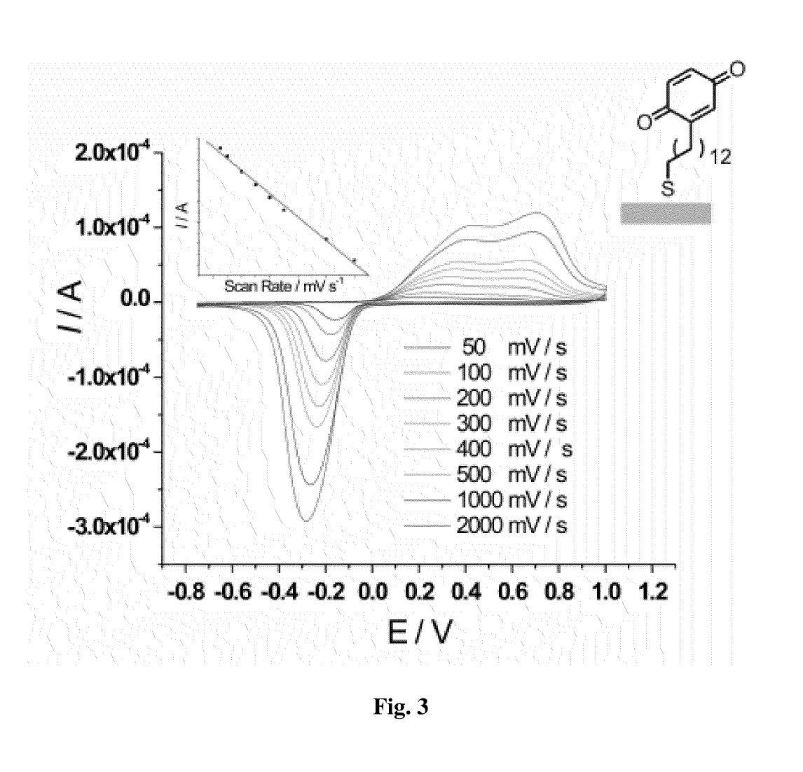

In accordance with one embodiment of the disclosure, a high resolution patterning method includes creating redox switchable surfaces that can be patterned with reagents using patterning methods. Referring to FIGS. 1 and 2, for example, the disclosed redox activating patterning method can include patterning a redox agent on a template layer formed on a substrate. The redox agent can be adapted to interact with the portion of the template layer that it contacts to transform that portion from a first oxidation state to a second oxidation state, different from the first. For positive-type patterning, a template pattern can be formed from the portion of the template layer having the second oxidation state. For negative-type patterning, a template pattern can be formed from the portion of the template layer having the first oxidation state. The remaining portion of the template layer, not apart of the template pattern, can function, for example, as a passivating layer. The resulting structure can be then exposed to a target material. The target material can selectively interact or bind to the template pattern, thereby forming the target pattern.

In accordance with an embodiment of the disclosure, a target pattern assembly can be formed by the patterning method of the disclosure. The target pattern assembly can include a substrate having a template layer and a redox agent pattern disposed on the template layer. The redox agent can be adapted to interact with the portion of the template layer that it contacts to transform the portion from a first oxidation state to second oxidation state. A positive-type template pattern can be formed when the template pattern is defined by the portion of the template layer having the second oxidation state. A negative-type template pattern can be formed when the template pattern is defined by the portion of the template layer having the first oxidation state. The target pattern assembly can further include a target material that selectively binds to the template pattern to form the target pattern.

The substrate can include insulating substrates, semiconducting substrates, and metal substrates. For example, the substrate can be a gold substrate, a Si/SiO₂ and glass having bio-relevant structures, including, unmodified proteins and amine-modified oligonucleotides. Other suitable substrate materials such as, indium tin oxide (ITO), titanium dioxide (TiO₂), aluminum oxide (Al₂O₃), iron oxide (Fe₂O₃), silicon (Si), gallium arsenide (GaAs), indium arsenide (InAs), silver, copper, poly(dimethylsiloxane (PDMS), poly(lysine), and combinations thereof can also be used. The substrate can be a multi-layered substrate. The template layer can be disposed directly on the substrate surface.

Prior to forming the template layer on the substrate surface, the substrate surface can be activated, for example, in a Piranha solution (3:1 concentrated H₂50₄ mixed with 30% H₂O₂ (aq)) at 60° C. for about 45 minutes. The Piranha solution can be washed off with water, and then the substrate can be dried, for example under a stream of N₂ gas. The substrate surface can further be modified to aid in bonding the template layer to the substrate. For example, amine groups can be added to the surface (FIG. 1). The amine groups can be added by immersing the substrate, such as a silicon/SiOₓ substrate, in a solution of aminopropyl trimethoxysilane (APTMS) under an inert atmosphere. The APTMS can be a 2% v/v solution in toluene. The substrate can remain immersed in the solution for about 5 hours. Other suitable times include about 5 minutes, 10 minutes, 15 minutes, 20 minutes 25 minutes, 30 minutes, 35 minutes, 40 minutes, 45 minutes, 50 minutes 55 minutes, 1 hour, 2 hours, 3 hours, 4 hours, 5 hours, 6 hours, 7 hours, 8 hours, 9 hours, and 10 hours. The substrate can then be rinsed, for example, with dry toluene and/or EtOH. Other known methods of functionalizing the substrate surface and other functional groups can be used and will vary depending on the type of substrate used and the type of template layer to be formed on the substrate. Other suitable functional groups include, for example, phosphoric acid, dimethoxy chlorosilane, trichlorosilane, methoxy dichlorosilane, triethoxy silane, dimethoxy chlorosilane, ethoxy dichlorosilane, alkene, alkyne, and combinations thereof. Alkene and alkyne functional groups can be especially useful in functionalizing silicon wafers after native oxide removal.

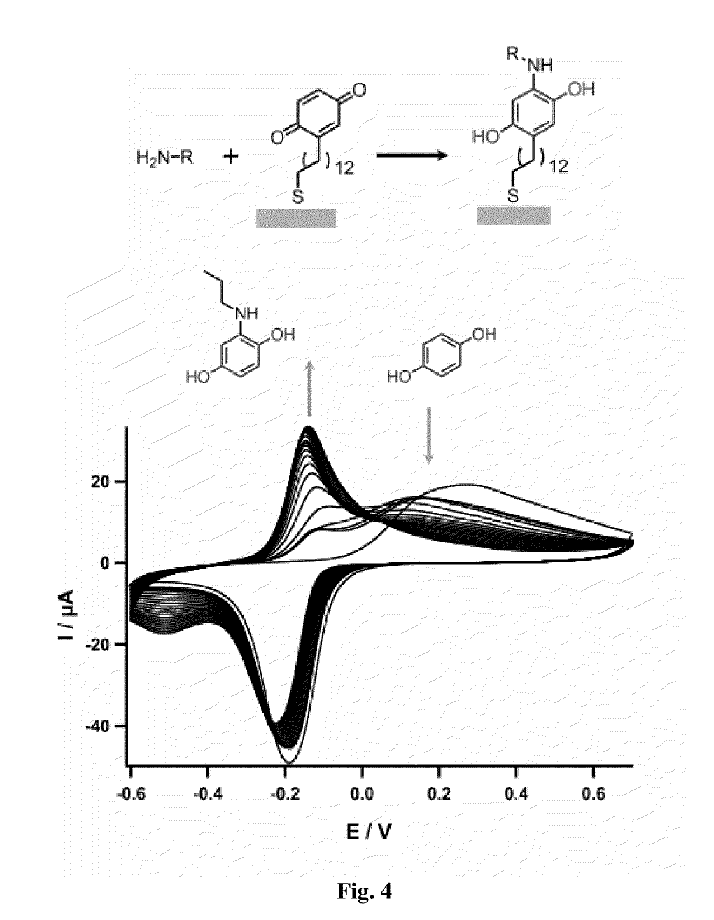

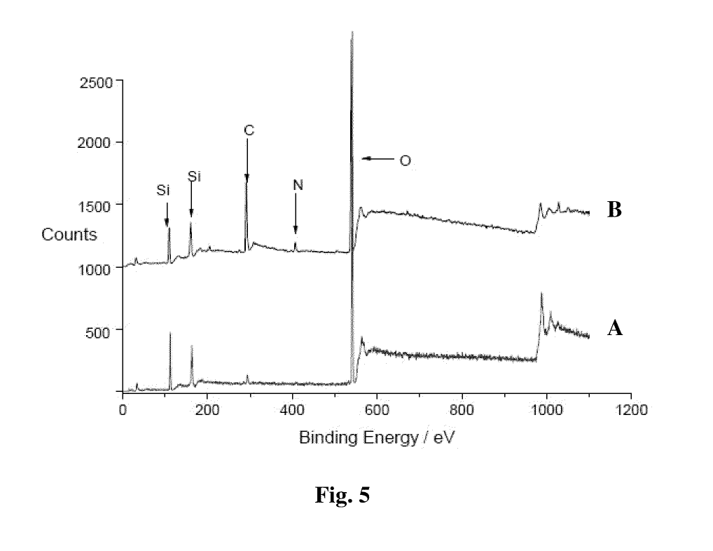

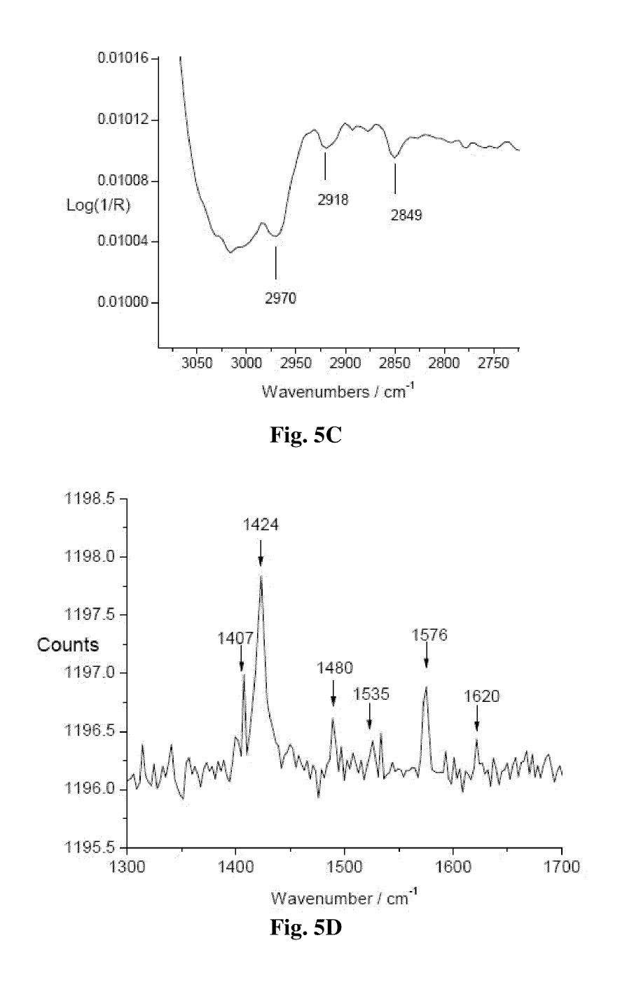

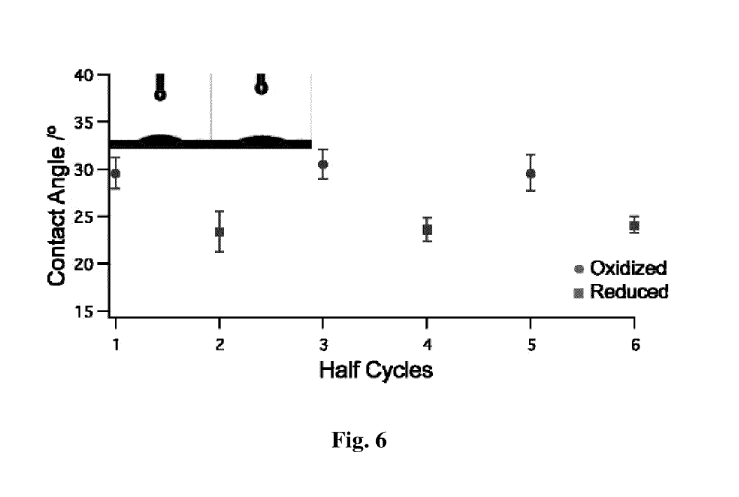

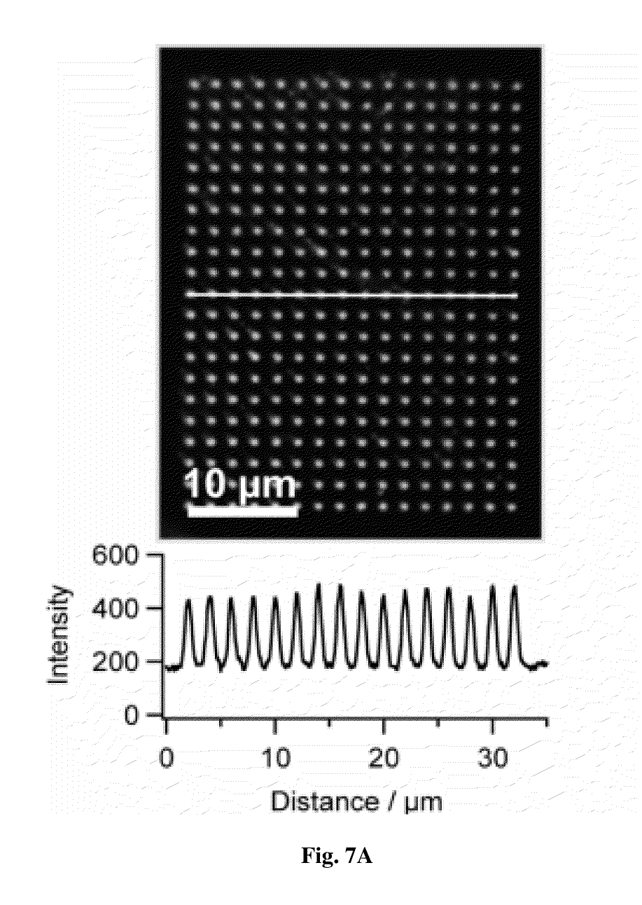

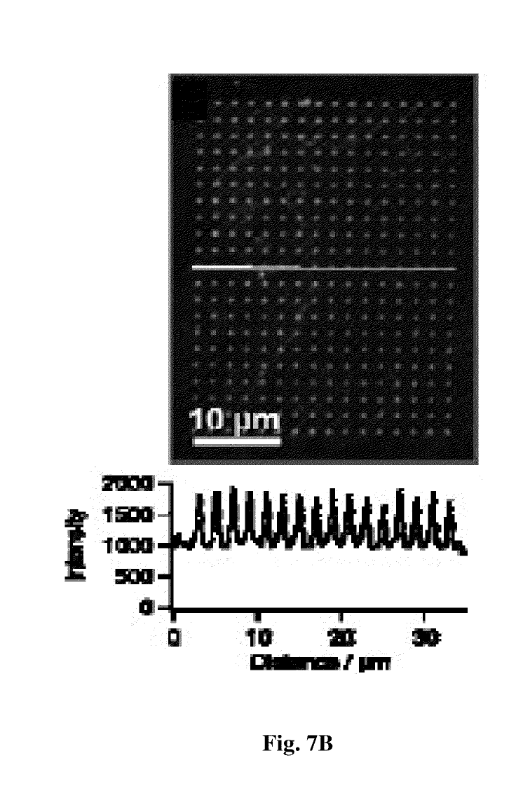

The template layer is formed or disposed on the substrate. As used herein “disposed on” refers to both direct and indirect contact of the template layer and the substrate. For example, the template layer can be indirect contact with one or more intermediary layers on the substrate, or the template layer can be in direct contact with the substrate. For example, the template layer can be formed for example of a quinone layer, such as hydroquinone or benzoquinone. Other suitable template layer materials include, for example, anthraquinone, napthylquinone, chloroquinone, cyanoquinone. For example, an amine modified substrate can be heated in a template material solution. The template material solution can be a quinone solution, such as, a 5 mM ethanolic solution of freshly sublimed 1,4-benzoquinone. The substrate can remain immersed in the template material solution for about 8 hours and can be heated to a temperature in a range of about 40° C. to about 50° C. Alternatively, the template layer can be formed, for example, using a vapor-phase process such as sublimation. Referring to FIGS. 2, 4A-C, and 5, the template layer can also be formed by modification of the deposited template material. For example, a quinone layer can be formed on the substrate and then reduced or oxidized to form the template layer having a desired first oxidation state. The benzoquinone layer formed as described above can be reduced to form, for example, a hydroquinone layer, which can then be used as the template layer. Sodium ascorbate, ascorbic acid, borane (BH₃), Zinc (Zn), formic acid, hydrazine, or palmitylascorbic acid (PAA) can be used as reductants, and ceric ammonium nitrate (CAN), iodine (I₂), potassium permanganate (KMnO₄), 2,3-dichloro-5,6-dicyanobenzoquinone (DDQ), chromium salts (Cr(III)), or osmium tetroxide can be used as an oxidant.

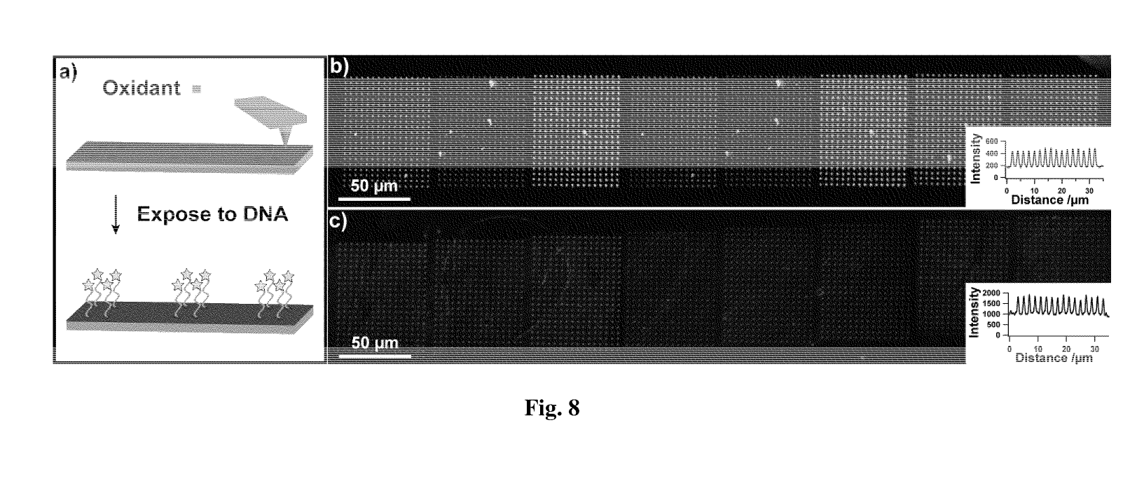

Referring to FIGS. 8A, 10A, 12A, and 14A, for positive patterning of the target material, the oxidation state of the template layer is chosen such that after patterning with the redox agent, the template pattern is formed of the portion of the template layer in contact with the redox agent and having a second oxidation state. For example, the template layer can be formed of a hydroquinone layer having a first oxidation state, such that upon patterning with an oxidant redox agent, the portion of the template layer in contact with the redox agent is changed to benzoquinone, which has a second oxidation state higher than the oxidation state of the template layer. The template pattern is, thus, formed of the benzoquinone portion, which selectively interacts with the target material when exposed to the target material to form the target pattern.

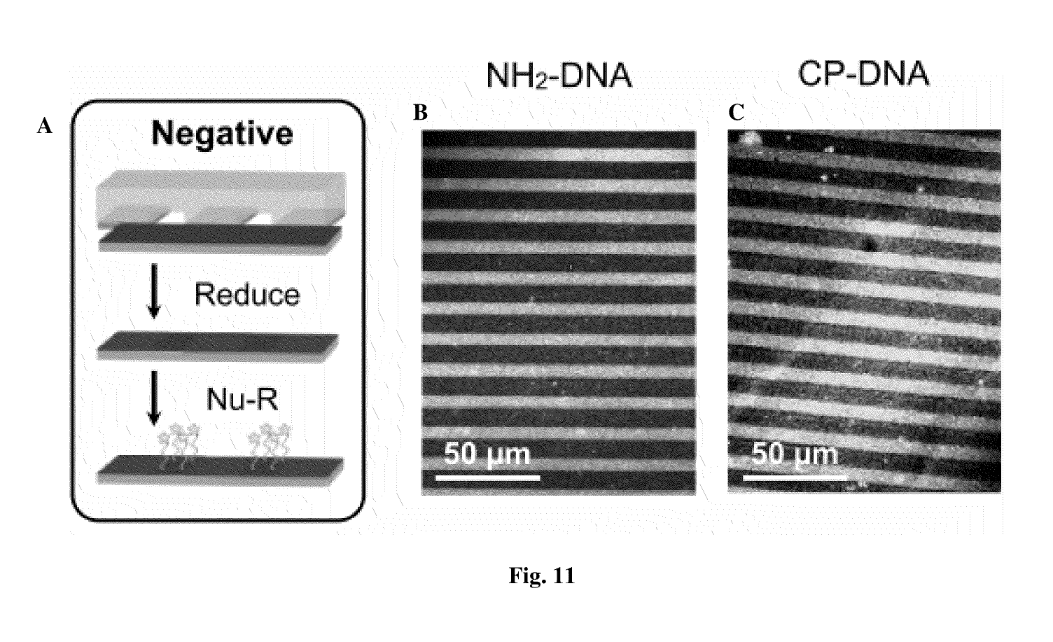

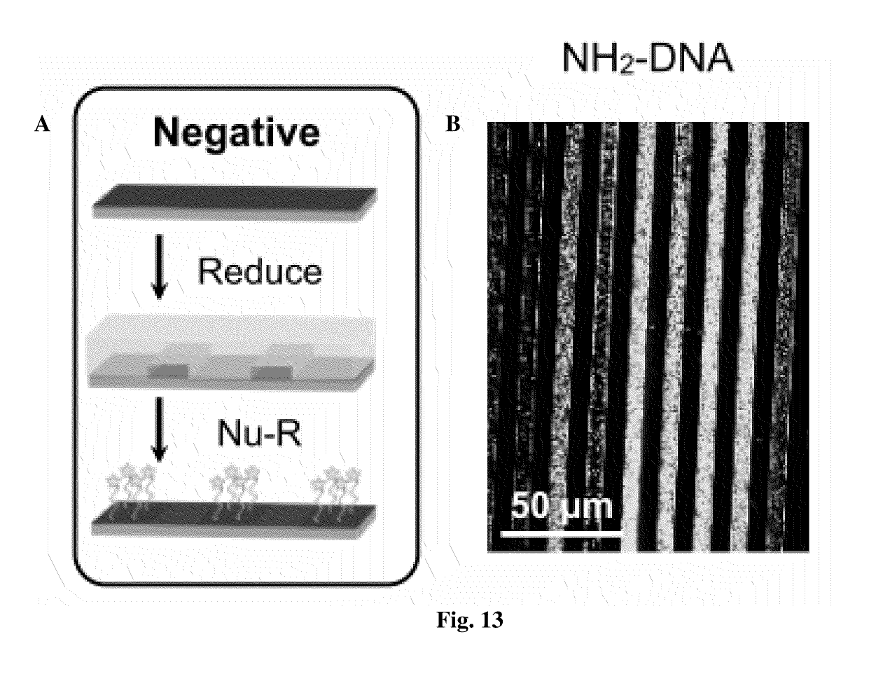

Referring to FIGS. 11A and 13A, for negative patterning of the target material, the template pattern is formed of the portion of the template layer having the first oxidation state. For example, the template layer can be formed of a benzoquinone layer having first oxidation state (i.e. the portion not contacted with the reducing agent), such that upon patterning with a reductant redox agent, the portion of the template layer in contact with the redox agent is changed to hydroquinone, which has a second oxidation state lower than the oxidation state of the template layer. The template pattern is formed of the benzoquinone portion, which selectively interacts with the target material when exposed to the target material to form the target pattern.

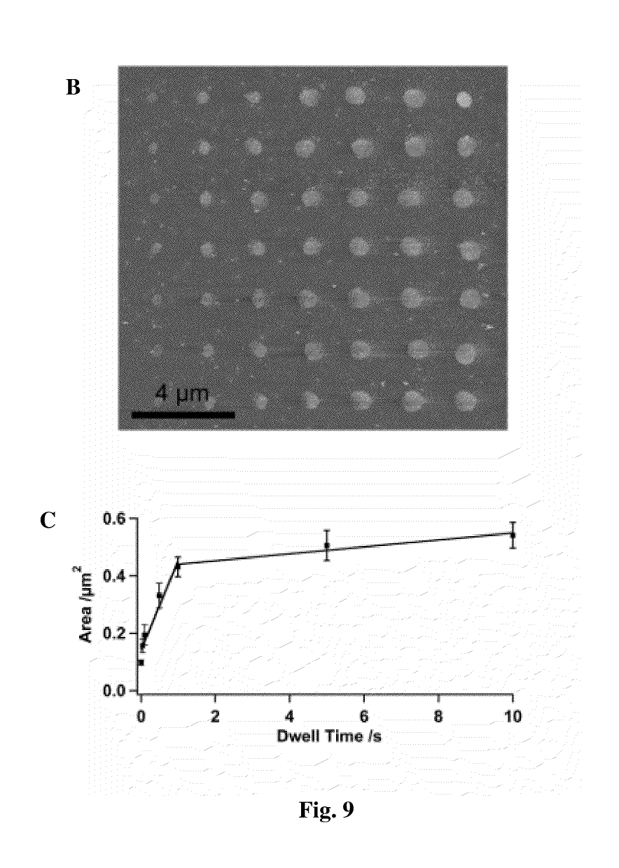

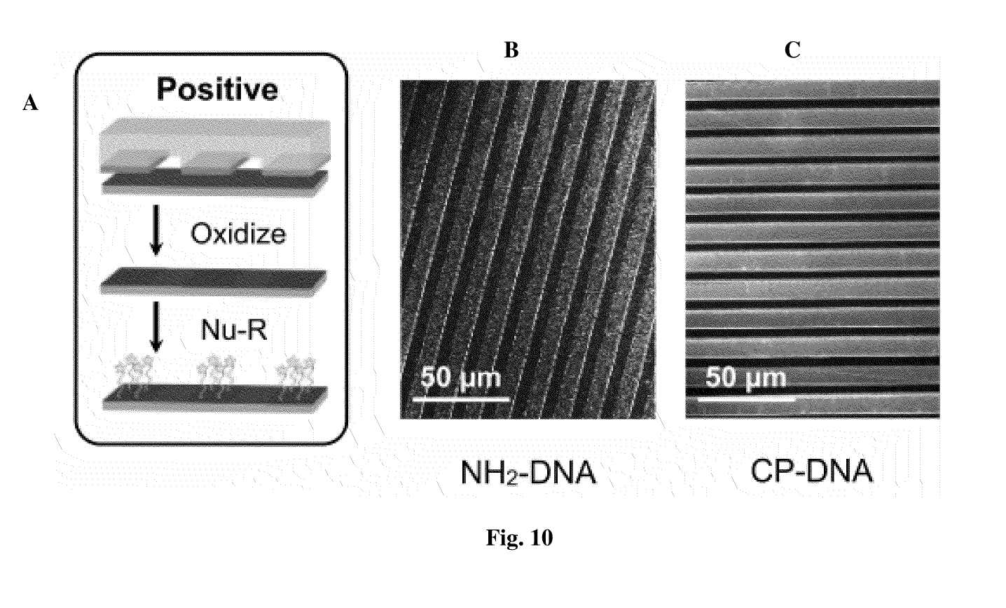

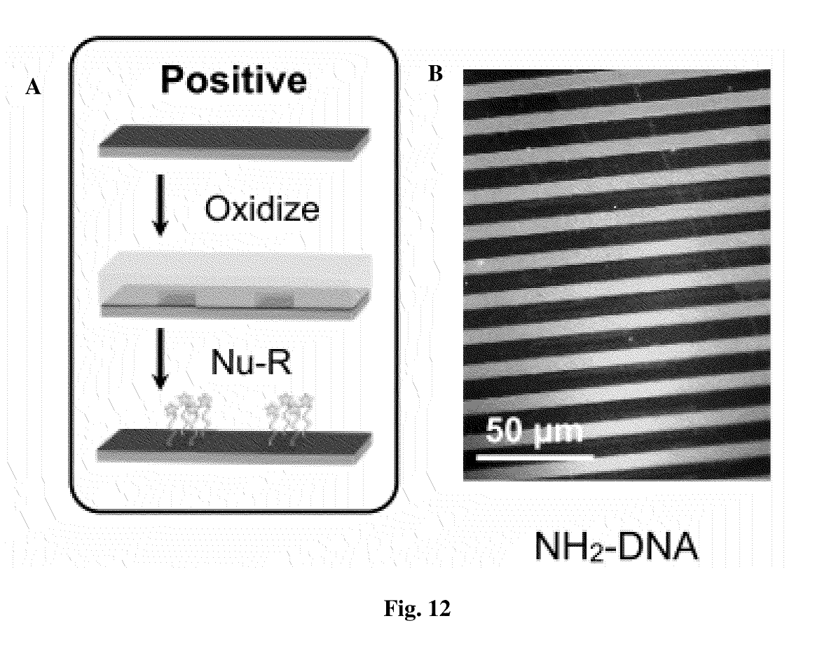

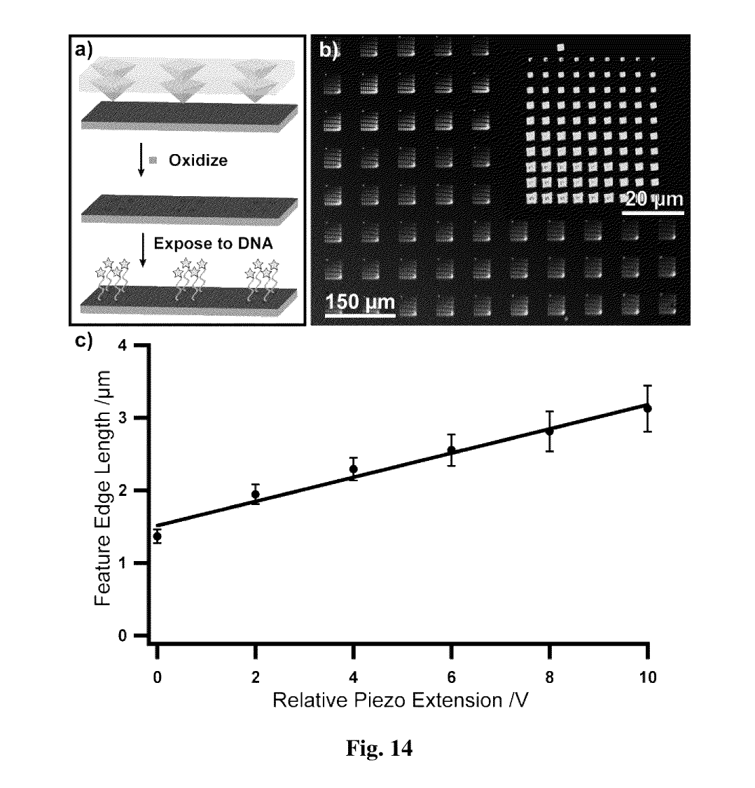

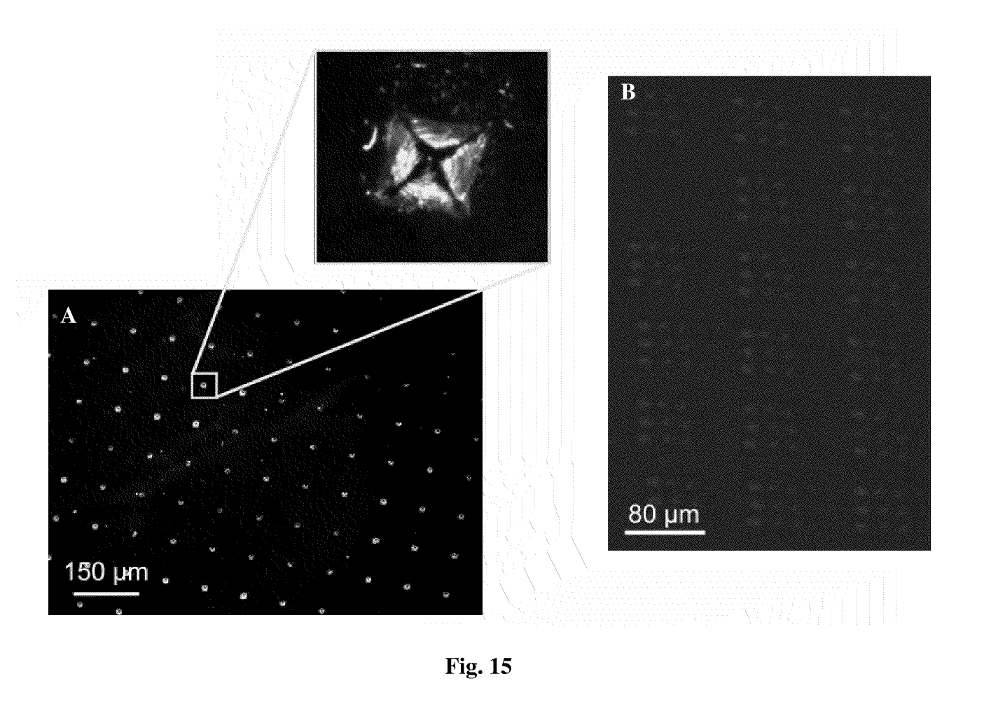

The redox agent can be patterned on the template layer using a variety of lithography or patterning methods including direct write patterning methods and method including use of tips, inks, and patterning compounds. Examples of patent literature for small scale patterning include: U.S. Pat. Nos. 6,827,979; 6,867,443; 6,635,311; US patent publications 2003/0068446; 2002/0122873; 2005/0009206; and WO 2009/132321. For example, the redox agent can be patterned using dip pen nanolithography (FIGS. 8A-8C), polymer pen lithography (FIGS. 14A-14C and 15A-15B, microcontact printing (FIGS. 10A-10C and 11A-11C), and microfluidic patterning (FIGS. 12A-12B and 13A-13B). Any other known patterning methods can also be used. Other methods include scanning probe contact printing and ink jet patterning. These patterning methods can allow for patterning of nano to microscale features over centimeter areas. Tips can include, for example, nanoscopic tips, SPM tips, AFM tips, hollow tips, solid tips, polymer tips, hard tips, cantilevered tips, or uncantilevered tips. Arrays of tips can be used including one dimensional and two dimensional arrays. For example, the redox agent can be patterned using a cantilevered tip. The redox agent can be applied to the tip using a intermediary layer such as paraffin. The paraffin can assist in enhancing the adhesion of the redox agent to the tip. For example, paraffin can be applied to coat the entire tip, forming liquid impermeable seal around the tip. One method of forming a liquid impermeable paraffin seal around the tip can include applying paraffin to the bottom of a glass dish and heating the dish at a temperature in a range of about 45° C. to about 50° C. to soften the paraffin for adhering to the tips. The tip including the cantilever can be placed on the softened paraffin. A second piece of paraffin can then be placed on top of the tips and molded around the tips such that only the cantilevers remain exposed. The top paraffin sheet can be heated at a temperature in a range about 45° C. to about 50° C. to soften the paraffin to ease the molding process. Other suitable temperatures for softening and molding the paraffin can be used depending on the type of paraffin used. The two paraffin sheets can be molded about the tip to form the liquid impermeable seal. The redox agent can then be applied to the paraffin modified tip and dried in an oven. For example, an about 10 μL drop of the redox agent can be applied to each paraffin coated tip and then dried onto the tip in an oven having high humidity. The oven can be heated to a temperature in a range about 45° C. to about 50° C. The tips can remain in the oven until the drop is evaporated, for example, about 10 minutes to about 15 minutes. Preferably, the tips are removed from the oven just after the drop has evaporated to avoid bending of the cantilevers as a result of longer exposure to the heat. This redox agent application/drying procedure can be repeated multiple times, for example, three times, to load the tip with a sufficient amount of the redox agent for patterning. The redox agent can be applied to the tip for patterning using any other known methods.

In one embodiment, the patterning is carried out without use of a mask or photomask.

When the redox agent is patterned using polymer pen lithography, the polymer pen tips can be modified with a silane oligo ethylene glycol prior to being loaded with the redox agent to enhance the adhesion of the redox agent to the tip. The silane oligo ethylene glycol modified polymer pen tips are especially suitable for use with water-soluble ionic inks. The polymer pen tips can be modified with the oligo(ethylene glycol) silane by first exposing the polymer pen tips, formed for example of PDMS, to oxygen plasma to create SiOH surface groups on the tips. The polymer pen tips can remain exposed to the oxygen plasma for about 30 seconds. The SiOH modified polymer pen tips can then be exposed to the oligo(ethylene glycol) silane, which can results in a reaction between the SiOH and the silane to bond the oligo(ethylene glycol)silane to the tips. The oligo(ethylene glycol) silane can include from about 3 to about 10 ethylene glycol units. For example, the oligo(ethylene glycol) can include 3, 4, 5, 6, 7, 8, 9, or 10 ethylene glycol units.

Preferably, the redox agent is patterned at about 40% to about 60% relative humidity. For example, the redox agent can be pattered at a minimum relative humidity of about 40%, 41%, 42%, 43%, 44%, 45%, 46%, 47%, 48%, 49%, 50%, 51%, 52%, 53%, 54%, 55%, 56%, 57%, 58%, 59%, or 60%. For example, the redox agent can be patterned at a maximum relative humidity of about 40%, 41%, 42%, 43%, 44%, 45%, 46%, 47%, 48%, 49%, 50%, 51%, 52%, 53%, 54%, 55%, 56%, 57%, 58%, 59%, or 60%. At a humidity less than about 40%, the transport of the CAN may be undetectable by AFM and little to no subsequent reaction with the template layer may be observed. At a humidity greater than about 60% the enhanced meniscus formation may make it difficult to remove the tip from the surface.

The redox agent can be any compound which, upon contact with the template layer, undergoes a redox process with the contacted portion of the template layer to change the oxidation state of the contacted portion of the template layer, while leaving unchanged the oxidation state of the non-contacted portion. The redox agent can be an oxidant, such as CAN, or a reductant, such as sodium ascorbate or PAA. For positive printing, the redox reaction between the redox agent and the template layer, preferably, oxidizes the contacted portion of the template layer, thereby increasing the oxidation state of the contacted portion. For negative printing, the redox reaction between the redox agent and the template, preferably, reduces the contacted portion of the template layer, thereby decreasing the oxidation state of the contacted portion.

The redox agent can be used in an ink formulation, and the ink formulation can comprise at least one solvent, at least one redox agent, and optional other formulation aids.

Optionally, the redox agent can be removed from the template pattern prior to exposing the template pattern to the target material. The redox agent can be removed, for example, by washing with deionized water.

The template pattern can be then exposed to the target material. For example, the substrate including the template pattern can be immersed in a solution containing the target material. For example, the substrate can be immersed in a 10 μM solution, of an oligonucleotide sequence, modified at the 5′ end with a nucleophile, such as an amine (see FIG. 8B). The target material can be a biomolecule. The target material can be a protein, and the substrate can be immersed, for example in a 5 μg/mL solution of a protein, for example an Alexa Fluor 594 labeled protein cholera toxin β (CTβ) subunit (see FIG. 8C). The template pattern can be exposed to the target material for a time in a range of about 10 minutes to about 24 hours. For example, the template pattern can be exposed to the target material for a minimum time of about 10 min, 15 min, 20 min, 25 min, 30 min, 35 min, 40 min, 45 min, 50 min, 55 min, 1 hour, 2 hours, 3 hours, 4 hours, 5 hours, 11 hours, 12 hours, 13 hours, 14 hours, 15 hours, 16 hours, 17 hours, 18 hours, 19 hours, 20 hours, 21 hours, 22 hours, 23 hours, or 24 hours. For example, the template pattern can be exposed to the target material for a maximum time of about 10 min, 15 min, 20 min, 25 min, 30 min, 35 min, 40 min, 45 min, 50 min, 55 min, 1 hour, 2 hours, 3 hours, 4 hours, or 5 hours.

The target material includes a functional group that selectively interacts with the template pattern, for example, by binding to the template pattern. By virtue of this selective interaction, for example through Michaels additions or Diels-Alder cycloaddition, the target material will form in the same pattern as the template pattern, thereby forming a target pattern. Target materials can include oligonucleotides, DNA, proteins, and mixtures thereof. For example, amine modified oligonucleotides and DNA, or cyclopentadiene modified oligonucleotides and DNA can be used as target materials. For example, the functional group of the target material can be for example, amine or cyclopentadiene groups. For example, the compound of formula (I) can be used to modified, for example, oligonucleotides and DNA,

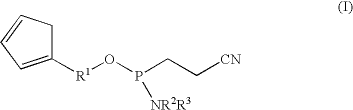

wherein R¹ is selected from the group consisting of C₁-C₂₀ alkylene, substituted C₁-C₂₀ alkylene, alkylene glycol, oligoethylene glycol, substituted oligoethylene glycol, C₂ -C₂₀ alkenylene, substituted C₂ -C₂₀ alkenylene, fluorocarbon, and substituted fluorocarbon, and R² and R³ are independently selected from the group consisting of hydrogen and C₁-C₁₀ alkyl. R² and R³ can be the same or different compounds. In a specific embodiment, the compound of formula (I) is

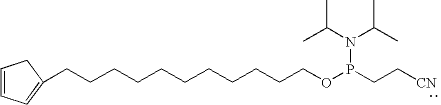

The term “alkyl” refers to straight chained and branched hydrocarbon groups containing the indicated number of carbon atoms, typically methyl, ethyl, and straight chain and branched propyl and butyl groups. Unless otherwise indicated, the hydrocarbon group can contain up to 20 carbon atoms. The term “alkyl” includes “bridged alkyl,” i.e., a C₆-C₁₆ bicyclic or polycyclic hydrocarbon group, for example, norbornyl, adamantyl, bicyclo[2.2.2]octyl, bicyclo[2.2.1]heptyl, bicyclo[3.2.1]octyl, or decahydronaphthyl. Alkyl groups optionally can be substituted, for example, with hydroxy (OH), halo, amino, and sulfonyl.

The term “alkene” refers to straight chained and branched hydrocarbon groups containing the indicated number of carbon atoms having at least one carbon-carbon double bond. Unless otherwise indicated, the hydrocarbon group can contain up to 20 carbon atoms. Alkene groups can optionally be substituted, for example, with hydroxy (OH), halo, amino, and sulfonyl.

Alkylene and alkenylene refer to alkyl and alkenyl groups, respectively having further defined substituents. For example, in the compound of formula (I), above, R¹ has a cyclopentadiene substituent and phosphoramidite substituent. Thus, when R¹ comprises straight chained and/or branched hydrocarbon groups, R¹ is referred to as having an alkylene moiety.

The term “oligoethylene glycol” refers to a moiety having 5 to 100 repeating ethylene glycol units, e.g., (CH₂CH₂)ₙ—OH, where n is 5 to 100. In some embodiments, n is 10 to 75, 10 to 50, 10 to 45, 10 to 35, 10 to 25, or 10 to 20. The oligoethylene glycol can optionally be substituted, for example, with hydroxy (OH), halo, amino, and sulfonyl. For instance, one or more ethylene glycol units can be CH(R)CH₂, where R is a hydroxy (OH), halo, amino, or sulfonyl.

The term “fluorocarbon” refers to an alkyl group having fluoro substituents. The fluorocarbon can have about 5 to about 100 carbons. In some embodiments, the fluorocarbon has 10 to 75, 10 to 50, 10 to 45, 10 to 35, 10 to 25, or 10 to 20 carbons. In some cases, the fluorocarbon has all fluoro substituents and no hydrogens. In other cases, the fluorocarbon, has at least 5, at least 10, at least 15, or at least 20 fluoro substituents. In one embodiment, perfluoro groups are used.

The term “alkylene glycol” refers to glycol moieties having 2 to 20 carbons, such as, for example, ethylene glycol or propylene glycol.

The amine or cyclopentadiene modification can selectively interact with the template pattern to immobilize the modified material (such as an oligonucleotide or DNA) on the surface of the template pattern to form the target pattern. The cyclopentadiene phosphoramidite functionality can be preferable to an acrylic diene for cycloaddition because the preorganized ring serves to increase the rate of reaction. Advantageously, the cyclopentadiene phosphoramidite can be economically synthesized as described in detail below.

The compound of formula (I) can be synthesized by mixing a cyanoethyl-dialkylamino-chlorophosphoramidite (formula (III)with a cyclopentadiene containing alcohol (formula (II)) and a base in a aprotic solvent, as depicted in the following scheme.

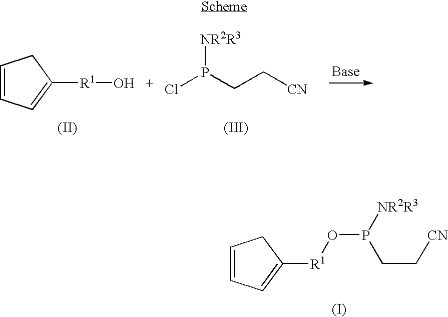

A non-limiting example of the compound of formula (III) is cyanoethyl N,N′-diisopropylchlorophosphoramidite. The compound of formula (II) can be

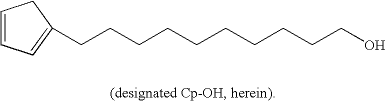

The base can be, for example, an organic base. Organic bases include, but are not limited to, amines, monosubstituted amines, disubstituted amines, and trisubstituted amines. Examples of substitutions of the amines include alkyl groups, such as methyl, ethyl, propyl, isopropyl, and butyl. The alkyl groups of the amine can be the same or different, for instances where the amine is a di- or tri-substituted amine. Specific examples of amine bases include triethylamine and diisopropylethylamine.

Aprotic solvents used in the disclosed methods include tetrahydrofuran, dimethylaminde, dimethylsulfoxide, methylene chloride. In one specific embodiment, the solvent is methylene chloride (CH₂Cl₂).

For example, cyclopentadiene phosphoramidite can be synthesized by mixing 2-cyanoethyl N,N′-diisopropylchlorophosphoramidite (for example, about 200 mg, 0.84 mmol) to a solution of Cp-OH (for example, about 0.5 g, 2.1 mmol) and diisopropyl ethylamine (for example, about 0.55 g, 4.2 mmol) in CH₂Cl₂ (for example, about 5 mL) under inert nitrogen atmosphere. The solution can be stirred for about 30 minutes. The solution can be diluted with CH₂Cl₂. For example, about 5 ml of CH₂Cl₂ can be used. The solution can then be washed. The washing solution can be 2.5% NaHCO₃ (aq) (5 mL) and a saturated brine solution (5 mL). The organic layer can the be dried, for example, over magnesium sulfate, which can be subsequently removed by filtration. The solvent can be removed in vacuo, and the remnant can be purified, for example, by column chromatography to obtain the cyclopentadiene phosphoramidite. The cyclopentadiene phosphoramidite can then be conjugated onto the oligonucleotide as is known in the art. The cyclopentadiene phosphoramidite can be used in applications other than redox-activated patterning, such as, for example, in ring opening metathesis polymer applications and in the formation of oligos.

The target material can also include, for example, metals, such as silver, gold, palladium, and platinum. Other suitable target materials include, for example, polymers, dendrimers, carbohydrates, antibodies, nucleic acids, nanoparticles, and quantum dots. The target material can also optionally include a fluorescent label, such as, for example, a Cy3 fluorophore or an AF549 label. Without intending to be bound by theory, it is believed that when benzoquinone or other similar material forms the template pattern and the target material includes a nucleophilic functional group, a Michael-type addition occurs between the nucleophile and the benzoquinone, binding the target material to the benzoquinone template pattern. The remaining portion of the template layer, for example, formed of hydroquinone unmodified by the redox agent, is not susceptible to nucleophilic attack in Michael-type additions and, therefore, does not react with the target material. When the target material is a protein, it is believed that a Michael-type addition occurs between the lysine residues that occur frequently on the exterior of proteins. The target material can also include a diene moiety, such as cyclopentadienes and acrylic dienes. Preferably, the diene moiety is cyclopentadiene phosphoroamidite. When the target material includes a diene moiety, it is believed that a Diels-Alder cycloaddition reaction selectively occurs between the diene and the benzoquinone or other similar template pattern material.

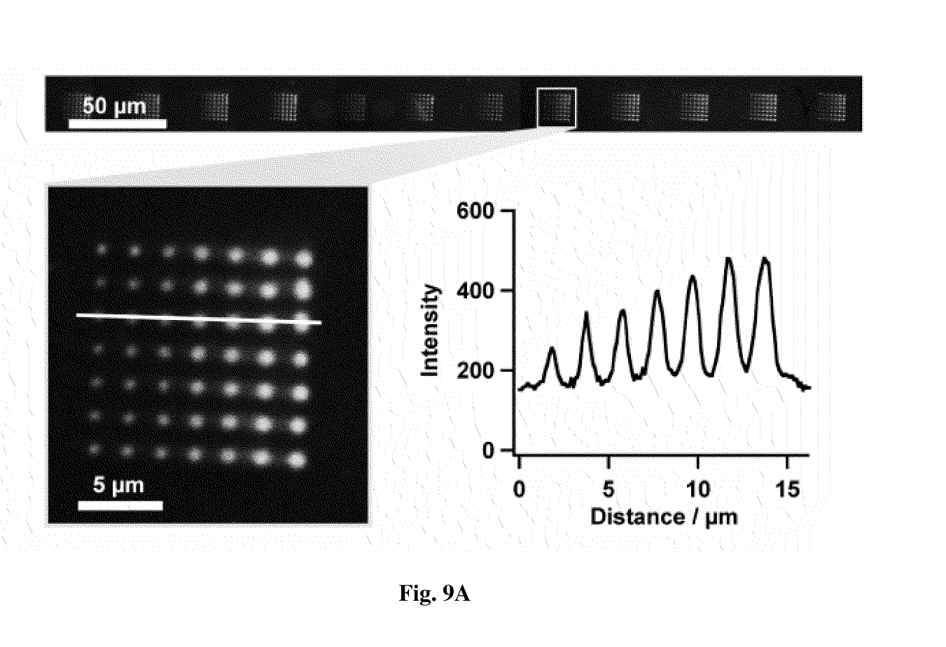

The methods of the disclosure allow for preservation of advantageous features of the patterning method used to pattern the redox agent, while providing a method that allows for patterning without the need for re-optimization of the method for each new target material to be patterned. For example, DPN advantageously allows for the ability to form patterns on a large range of length scales with precise control over size by varying dwell time. In the methods of the disclosure, this control over size can be used to control the size of the target pattern. The redox agent can be patterned to different sizes by controlling and carrying the dwell time of the AFM tip when patterning the redox agent. Dwell times in a range of about 0.01 seconds to about 10 seconds can be used. Preferably, the minimum dwell time is about 0.01, 0.05, 0.1, 0.5, 1, 2, 3, 4, 5, 6, 7, 8, 9, or 10. Preferably, the maximum dwell time is about 0.01, 0.05, 0.1, 0.5, 1, 2, 3, 4, 5, 6, 7, 8, 9, or 10. As shown in FIGS. 9A-9C, the varied size of the patterned redox agent also results in a target pattern having correspondingly varied sizes. Accordingly, the size of the target pattern can ultimately be controlled and varied, when patterning DPN, by varying the dwell time when patterning the redox agent.

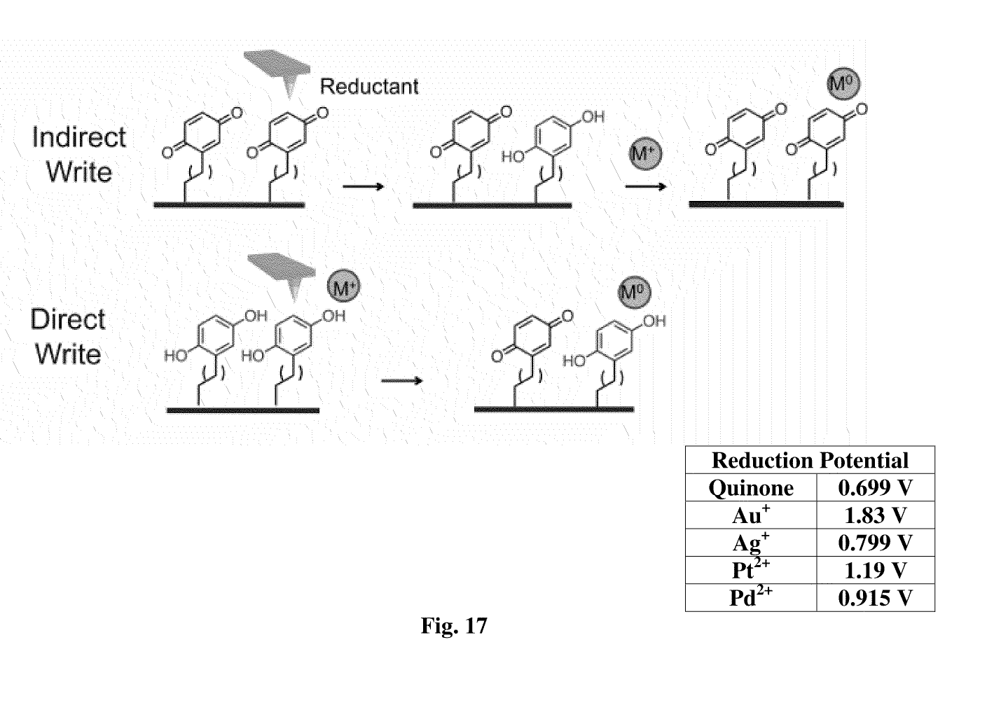

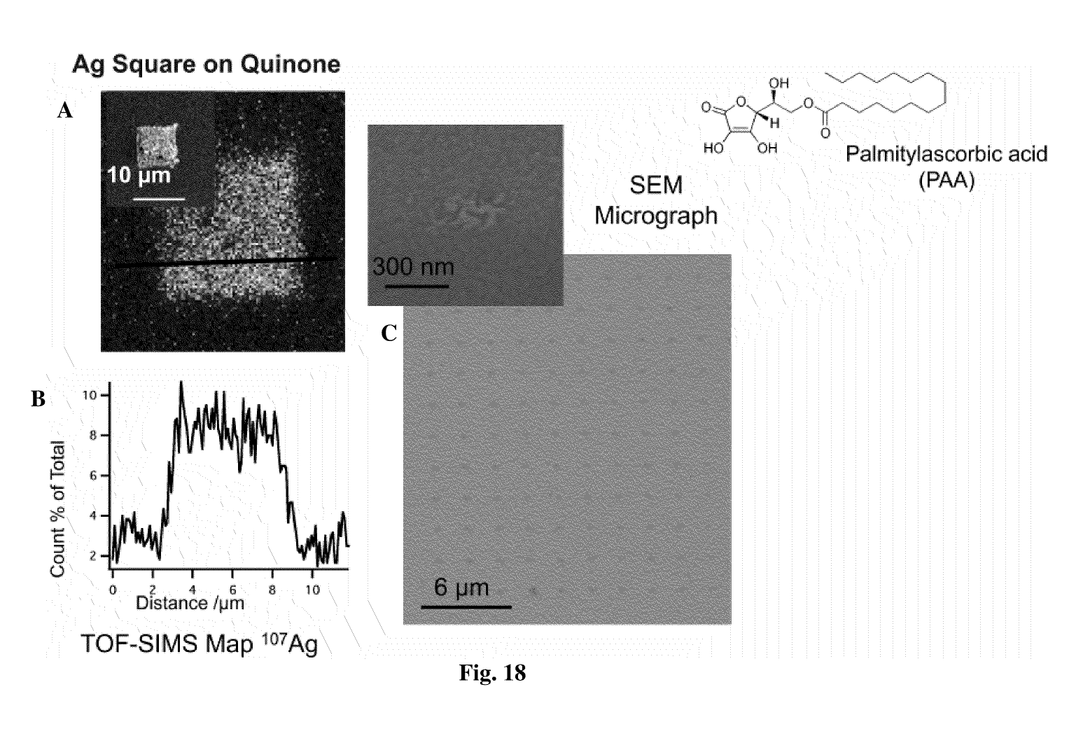

Referring to FIG. 17, in accordance with another embodiment of the disclosure, metal structures can be formed by direct and indirect methods. Metal structures can be formed indirectly by patterning a redox agent on a template layer to form a template pattern, as described above. The template pattern is formed to have the desired shape, size, and orientation of the metal structure to be formed. The resulting structure can then be exposed to a metal ion or a metal containing compound. Upon exposure to the template pattern, the metal ion or metal containing compound selectively interacts with and is reduced by the template pattern, thereby binding a metal to the template pattern. Referring to FIGS. 18A-18C, a benzoquinone template layer can be formed on a substrate. A reductant, such as PAA, can be patterned on the benzoquinone template layer, thereby oxidizing the portion of the benzoquinone layer in contact with the reductant and changing it, through a redox reaction, to a hydroquinone surface. The resulting structure can then be exposed to a metal ion or a metal containing compound, such as AgNO₃. The metal containing compound or metal ion is reduced by the hydroquinone surface, which causes the hydroquinone surface to convert back to a benzoquinone surface, and results binding of a metal, for example, Ag, to the benzoquinone surface. The patterned metal can be, for example, a square, a dot, or a line. Other metal structures that can be formed include metal nanoparticles, nanorods, and nanowires.

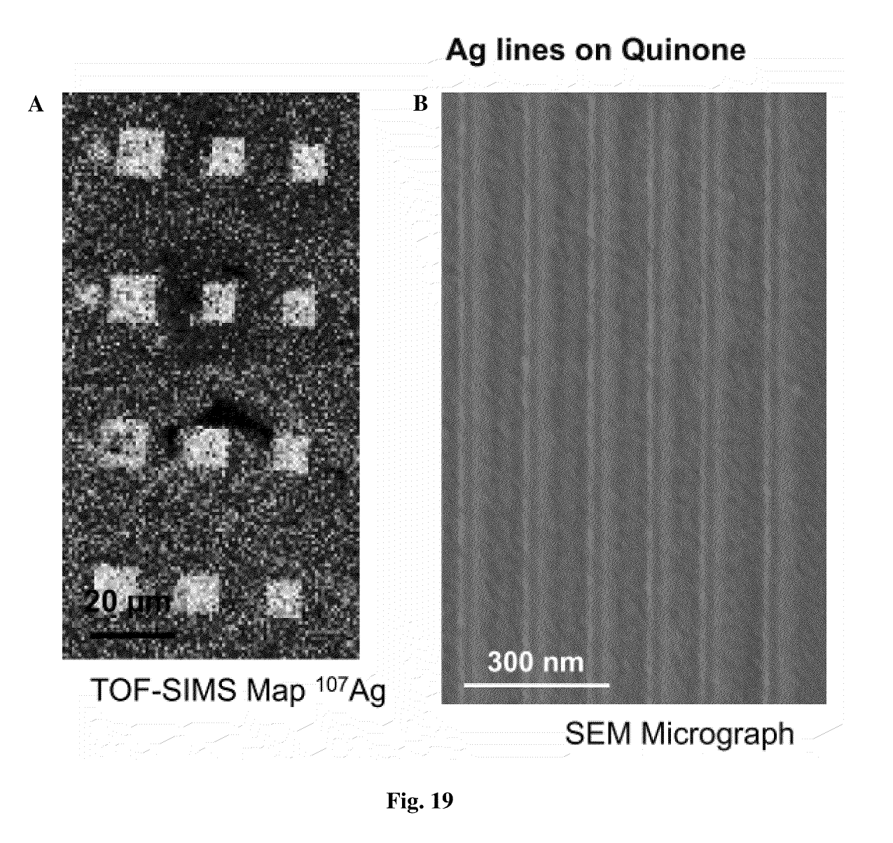

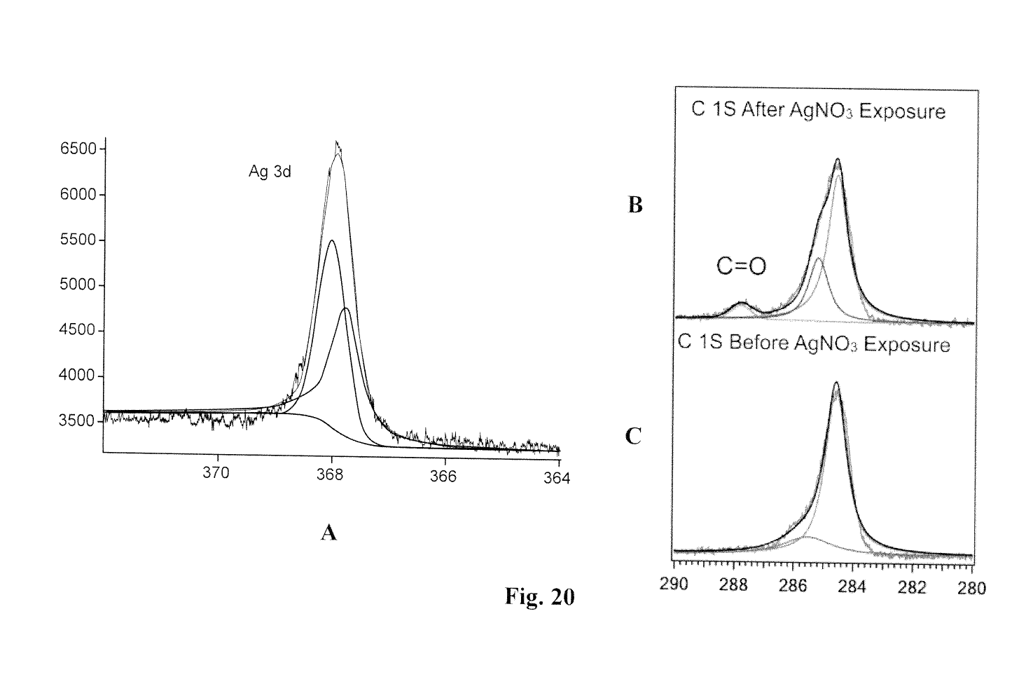

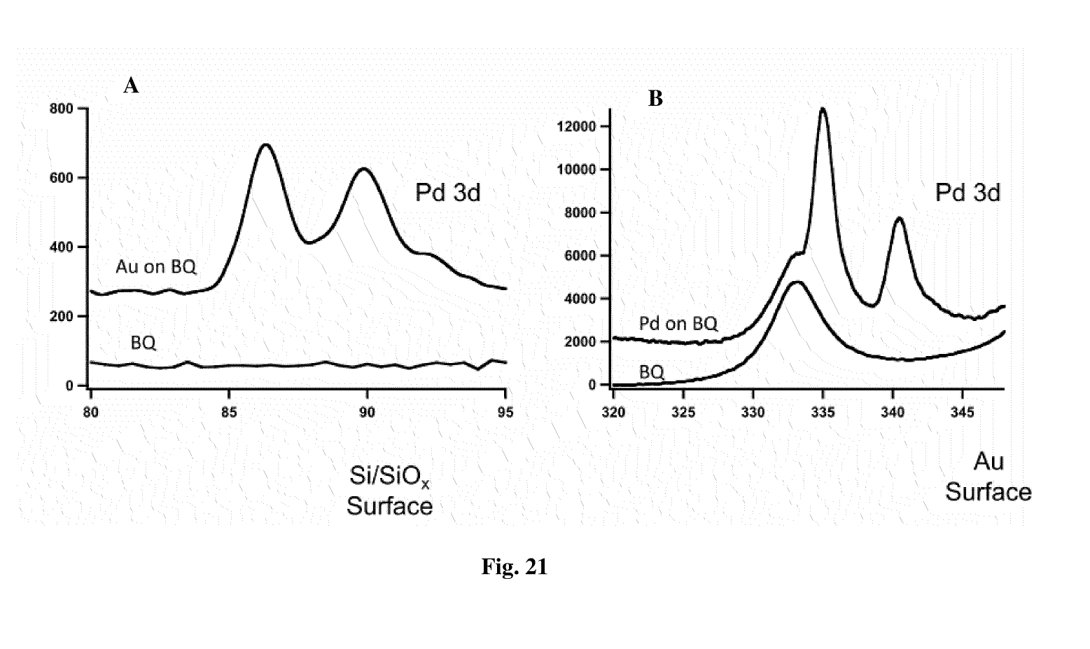

Referring to FIGS. 17, and 19A-19B, in accordance with another embodiment of the disclosure, the metal structure can also be formed by a direct patterning method. A metal ion or metal containing compound can be patterned on a template layer, which reduces the metal ion or metal containing compound, resulting in a metal structure bound to a portion of the template layer. The metal ion or metal containing compound can be patterned using any known patterning method, such as, for example, dip-pen nanolithography, polymer pen lithography, microcontact printing, and microfluidic patterning.

The metal can be for example, gold, silver, platinum, palladium, zinc, iron, cobalt, copper, aluminum, titanium, and mixtures thereof. Any other suitable metal can be used. The metal species can be included in a metal containing compound, such as for example, AgCl, AgNO₃, AgBF₄, Ag(acac), and AgPF₆. Any other suitable metal species can be used.

### Kit for Forming a Target Pattern

In accordance with another embodiment of the disclosure, a kit can be provided including, for example, a kit for patterning a target pattern can be provided. The kit can include one or more kit components, including, for example, at least one substrate having a template layer, at least one redox agent, at least one tip, or an array of tips for patterning the redox agent on the template layer, and/or instructions for using the kit including software and hardware. As described above, the redox agent can be adapted to transform the portion of the template layer contacted with the redox agent from a first oxidation state to a second oxidation state, different than the first oxidation state. A template pattern can be formed either from the portion of the template layer having the first oxidation state or the portion of the template layer having the second oxidation state. The kit can further include a target material that can be adapted to selectively bind to the template pattern to form the target pattern. The kits can be used in conjunction with lithography and patterning instrumentation including software and hardware.

Additional aspects and details of the invention will be apparent from the following examples, which are intended to be illustrative rather than limiting.

### Example

### Example 1

### Oligonucleotide Patterning Using RA-DPN

An animated surface was formed by immersing an oxidized silicon wafer having a 525 nm SiO₂ layer in a 1% (v/v) solution of aminopropyl trimethoxysilane (APTMS) in dry toluene for about 5 hours in an oxygen free environment. The resulting surface, upon exposure to an ethanolic solution of freshly sublimed 1,4 benzoquinone, form a benzoquinone-terminated surface through Michael Addition. The surface was then reduced to form hydroquinone-terminated surface.

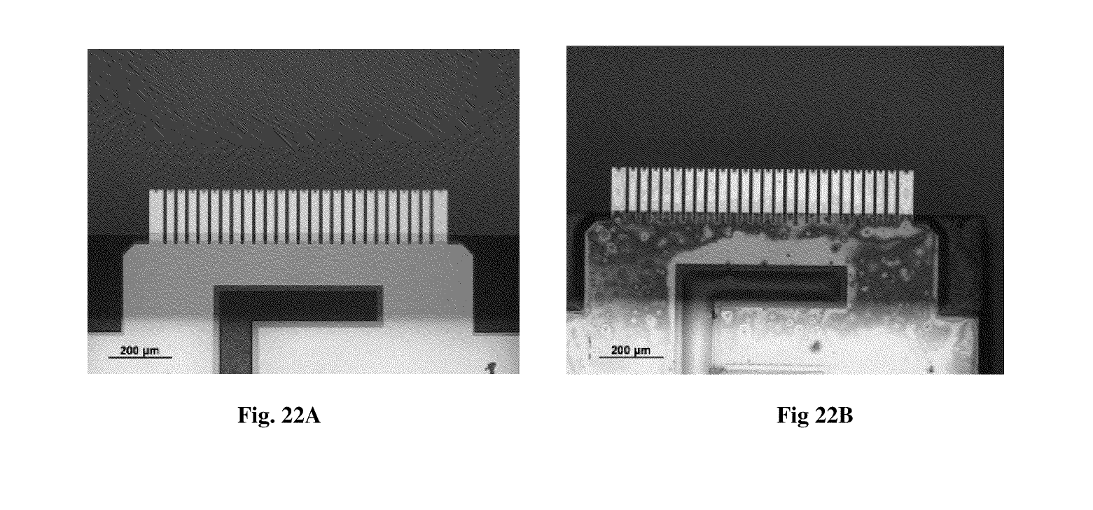

The redox agent, CAN, was patterned by dip pen nanolithography using an NSCRIPTOR DPN system (NanoInk Inc., IL) with F type 26 pen tips arrays (NanoInk). Cantilever arrays were prepared for dip-pen nanolithography with CAN, an oxidant. Parafilm was used to sandwich the chip holding the array of 26 cantilevers so that the aqueous CAN solution (40 mM) deposited as a 5 μL drop by micropipette would remain localized on the cantilevers. Referring to FIGS. 22A and 22B, the coated cantilever array was dried in an oven to form an even coating of CAN on the tips.

The coated tips were used to form patterns on the HQ-terminated surface. Deposition of the CAN redox agent on the hydroquinone-terminated surface activated the surface through local oxidation to benzoquinone. Deposition was performed at a relative humidity of about 40% to about 60%. The hydrophilic nature of the substrate facilitated the formation of a meniscus on the tip, and as a result, facilitated the transport of the CAN redox agent to the surface. The substrate having the CAN pattern was then washed with deionized water to remove the CAN redox agent. The substrate having the benzoquinone patterns resulting from the CAN deposition was then immersed for about two hours in a 10 μM solution of the target patterning compound, in this case, an oligonucleotide sequence, modified at the 5′ end with an amine and at the 3′ end with a Cy3 fluorophore. Referring to FIG. 9A, the target patterning compound was bound only to the benzoquinone patterns, forming a target compound pattern (i.e. an oligonucleotide pattern). The fluorophore was used to image the oligonucleotide pattern by epifluorescene microscopy.

### Example 2

### Protein Patterning Using RA-DPN

The method of example 1 was repeated except, the substrate having the benzoquinone pattern was immersed in a 50 μg/mL solution of AF549 labeled protein cholera toxin β. The protein was bound only to the benzoquinone patterns, forming a protein pattern. The AF549 label allowed for imaging of the protein pattern using epifluorescence microscopy. Without intending to be bound by theory, it is believed that Michael addition occurs between the benzoquinone moieties on the surface and the lysine residues that occur frequently on the exterior of proteins, resulting in the immobilization of the proteins on the surface without prior labeling. Referring to FIG. 9B, the protein pattern was then exposed to a fluorophore-labeled complementary antibody (for the protein). Binding was observed, which indicated that the protein pattern maintained bioactivity.

### Example 3

### DNA Patterning Using RA-Microcontact Printing with a Positive Pattern

Referring to FIG. 10A, a DNA pattern was formed using a positive patterning method in accordance with an embodiment of the disclosure using microcontact printing. Microcontact printing stamps were fabricated by applying a standard mixture of SLYGARD 184 PDMS prepolymer and curing agent (10:1 w/w) (Dow Corning, Michigan) to a silicon master with 10 μm wide trenches separated by 5 μm wide protrusions, and cured at a temperature of about 60° C. overnight. The stamp was inked with the redox agent, CAN, by applying a drop of aqueous CAN (5 mM) to the stamp, which was made hydrophilic by exposure to O₂ plasma, for about 2 min. After drying under a stream of N₂, the stamp was placed in conformal contact with an HQ template layer for about 1 min. The template layer was then washed with water and dried with N₂. The portions of the template layer that contacted the CAN underwent a redox reaction with the CAN and formed benzoquinone template patterns. The resulting structure was washed with water and then immersed in a solution of DNA modified at the 3′ end with a hexyl amine and at the 5′ end with a Cy3 fluorophore for about 2 hours. Referring to FIG. 10B, a fluorescent pattern of 10 μm wide lines spaced 5 μm apart was observed by epifluorescence microscopy, which mirrored the stamp pattern.

### Example 4

### DNA Patterning Using RA-Microcontact Printing with a Negative Pattern

Referring to FIG. 11A, a DNA pattern was formed using a negative patterning method in accordance with the disclosure using microcontact printing. The microcontact stamp was formed as in Example 3, and inked with a redox agent, sodium ascorbate (5 mM). The inked stamp was placed in conformal contact with a benzoquinone template layer for about 1 min. The portions of the template layer that contacted the sodium ascorbate redox agent underwent a redox reaction with the sodium ascorbate and formed hydroquinone patterns. The template pattern was formed of the portion of the template layer not in contact with the redox agent, which remained benzoquinone. The resulting structure was washed with water and immersed in a solution of amine modified, Cy3 labeled DNA. Referring to FIG. 11B, a fluorescent pattern of 5 μm wide lines spaced 10 μm apart was observed by epifluorescence microscopy, corresponding to portions of the stamp not in contact with the template layer surface. The results of Example 3 and 4 indicated that the DNA selectively reacted only where the kinetically stable benzoquinone form persisted on the surface. Without intending to be bound by theory, it is believed that the DNA selectively interacts with the benzoquinone portion by Michael addition.

### Example 5

### DNA Patterning Using RA-Microcontact Printing

The methods of Examples 3 and 4 were repeated except that the DNA was modified with cyclopentadiene phosphoroamidite and a Cy3 fluorophore.

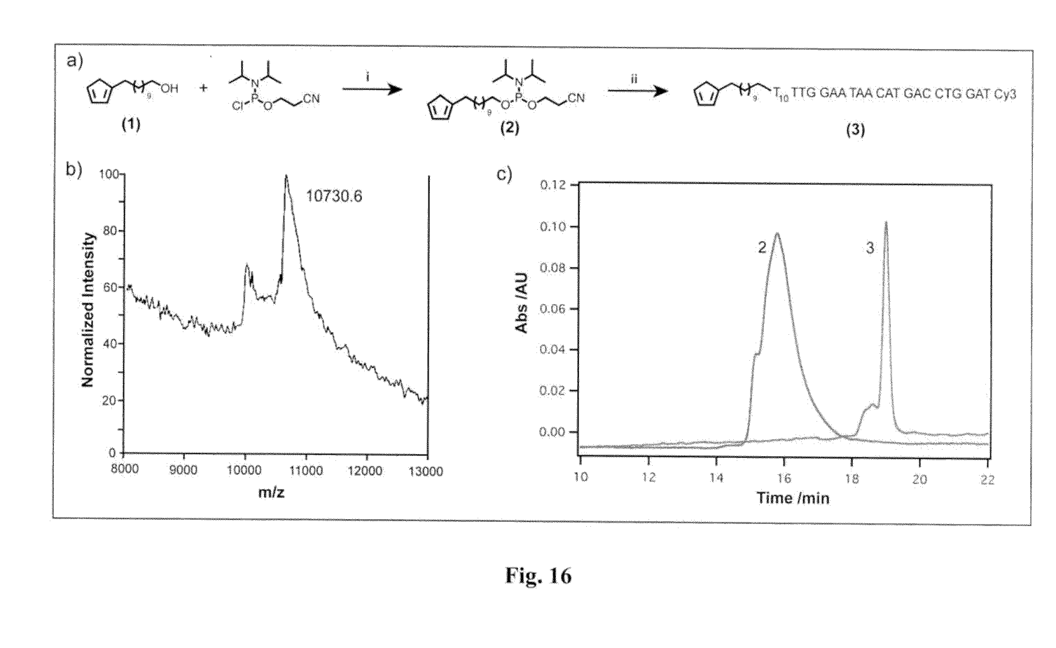

Referring to FIG. 16A, cyclopentadiene (Cp) phosphoramidite was prepared by adding 2-cyanoethyl N,N′-diisopropylchlorophosphoramidite (200 mg, 0.84 mmol) to a stirring solution of Cp-OH (0.5 g, 2.1 mmol) and diisopropyl ethylamine (0.55 g, 4.2 mmol) in CH₂Cl₂ (5 mL) under inert nitrogen atmosphere. Stirring was continued for about 30 minutes. The solution was then diluted with 5 mL of CH₂Cl₂. The reaction solution was then washed with 2.5% NaHCO₃ (aq) (5 mL) and a saturated brine solution (5 mL). The organic layer was dried over magnesium sulfate, which was subsequently removed by filtration. The solvent was removed in vacuo, and the remnant was purified by column chromatography (Alumina Type I, 5:95 ethyl acetate:hexane: 1% triethylamine) to afford a clear oil (160 mg, 17%).

The cyclopentadiene phosphoramidite was conjugated to the 5′ end of an oligonucleotide sequence immobilized on a solid support using standard phosphoramidite conditions. The modified oligonucleotide was then purified by reverse phase HPLC. Referring to FIGS. 16B and 16C, ligation of the cyclopentadiene phosphoroamidite was confirmed by high-resolution MALDI mass spectrometry and RP-HPLC, which showed a 3 minute increase in retention time for the ligated oligonucleotide. The cyclopentadiene tag was a sufficient hydrophobic handle to separate the oligonucleotide from truncated products without the standard dimethoxytrityl moiety.

Referring to FIGS. 10C and 11C, both positive and negative patterns were formed using microcontact printing as described in Examples 3 and 4. The patterns reached full fluorescent intensity in a little as thirty minutes after exposure of the template pattern to the cyclopentadiene modified DNA, as compared to two hours for the amine modified DNA. Without intending to be bound by theory, it is believed that the template pattern and the cyclopentadiene modified DNA undergoes a Diels Alder cycloaddition. It is further believed that cyclopentadiene functionality is preferable to an acrylic diene for cycloaddition because the preorganized ring serves to increase the rate of reaction.

### Example 6

### DNA Patterning Using RA-Microfluidic Patterning

Examples 3 and 4 were repeated except that the redox agent was patterned using microfluidic patterning. Microfluidic patterning was performed by applying a patterned stamp to the substrate and applying a drop of the redox agent adjacent to the stamp. Capillary forces draw the redox agent into the channels of the patterned stamp allowing the redox agent to flow through the channels and react with the template layer on the substrate transforming the contacted portion of the template layer to a second oxidation state. As shown in FIGS. 12A and 13A, both positive and negative patterns were formed using microfluidic patterning.

The foregoing describes and exemplifies the invention but is not intended to limit the invention defined by the claims that follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein, without departing from the concept, spirit, and scope of the invention. More specifically, it will be apparent that certain agents which are both chemically and physiologically related may be substituted for the agents described herein while the same or similar results would be achieved. All such similar substitutes and modifications apparent to those of ordinary skill in the art are deemed to be within the spirit, scope, and concept of the invention as defined in the appended claims.

1. A method of forming a target pattern, comprising
patterning a redox agent on a template layer disposed on a substrate, the template layer having a first oxidation state, wherein upon contact with the redox agent, the contacted portion of the template layer changes to a second oxidation state different than the first oxidation state, and a template pattern is formed from the portion of the template layer having either the first oxidation state or the second oxidation state; and
exposing the substrate having the template pattern to a target material, wherein the target material selectively binds to the template pattern to form a target pattern.

2. The method of claim 1, wherein the substrate is selected from the group consisting of insulating substrates, semiconducting substrates, and metallic substrates.

3. The method of claim 1, wherein the substrate is a silicon wafer comprising a silicon dioxide layer.

4. The method of claim 1, wherein the template layer is a quinone layer.

5. The method of claim 4, wherein the first oxidation state is lower than the second oxidation state.

6. The method of claim 5, wherein first oxidation state is hydroquinone and the second oxidation state is benzoquinone.

7. The method of claim 5, wherein the template pattern comprises the portion of the template layer having second oxidation state.

8. The method of claim 5, wherein the redox agent is an oxidant.

9. The method of claim 8, wherein the redox agent is ceric ammonium nitrate.

10. The method of claim 4, wherein the first oxidation state is higher than the second oxidation state.

11. The method of claim 10, wherein first oxidation state is benzoquinone and the second oxidation state is hydroquinone.

12. The method of claim 1, wherein the template pattern comprises the portion of the template layer having the first oxidation state.

13. The method of claim 10, wherein the redox agent is a reductant.

14. The method of claim 13, wherein the reductant is sodium ascorbate.

15. The method of claim 1, wherein the target material is selected from the group consisting of an oligonucleotide, DNA, a protein, a polymer, a dendrimer, a carbohydrate, an antibody, a nucleic acid, a nanoparticle, a quantum dot, and mixtures thereof.

16. The method of claim 1, wherein the target material is biomolecule.

17. The method of claim 15, wherein the target material is an oligonucleotide having cyclopentadiene phosphoramidite conjugated to the 5′ end of the oligonucleotide.

18. The method of claim 1, wherein the target material comprises a metal.

19. The method of claim 18, wherein the metal is selected from the group consisting of Ag, Au, Pd, Pt, and mixtures thereof.

20. The method of claim 1, further comprising removing the redox agent from the template layer prior to exposing the template pattern to the target material.

21. The method of claim 1, comprising patterning the redox agent using a patterning method selected from the group consisting of dip-pen nanolithography, polymer pen lithography, microcontact printing, and microfluidic patterning, and combinations thereof.

22. The method of claim 1, wherein the patterning comprises use of a tip to deposit the redox agent on the template material.

23. A method of forming a metal structure, comprising:
patterning a redox agent on a template layer formed on a substrate, the template layer having a first oxidation state, the redox agent adapted to change the oxidation state of a portion of the template layer in contact with the redox agent to a second oxidation state different from the first oxidation state, wherein a template pattern is formed from the portion of the template layer having either the first or second oxidation state; and
exposing the template pattern to a metal ion or metal containing compound, the metal ion or metal containing compound being reduced by the template pattern to form a metal structure disposed on the template pattern.

24. The method of claim 23, wherein the metal structure comprises a metal selected from the group consisting of Ag, Au, Pd, Pt, and mixtures thereof.

25. The method of claim 23, further comprising removing the redox agent from the template layer prior to exposing the template pattern to the target material.

26. The method of claim 23, comprising patterning the redox agent using a patterning method selected from the group consisting of dip-pen nanolithography, polymer pen lithography, microcontact printing, and microfluidic patterning.

27. A method forming a metal nanostructure, comprising:
patterning a metal ion or a metal containing compound on a template layer having a first oxidation state, the template layer adapted to reduce the metal containing compound when in contact with the metal ion or metal containing compound, thereby forming a metal structure on the template layer.

28. The method of claim 27, wherein the metal structure comprises a metal selected from the group consisting of Ag, Au, Pd, Pt, and combinations thereof.

29. The method of claim 27, comprising patterning the metal ion or metal containing compound using a patterning method selected from the group consisting of dip-pen nanolithography, polymer pen lithography, microcontact printing, and microfluidic patterning.

30. A target pattern formed by the method of claim 1.

31. A target pattern assembly, comprising
a substrate;
a template layer disposed on the substrate, the template layer having a first portion having a first oxidation state and a second portion having a second oxidation state, wherein a template pattern is defined by either the first or the second portion; and
a target material disposed on the template pattern.

32. The target pattern of claim 31, wherein the substrate is selected from the group consisting of insulating substrates, semiconducting substrates, and metallic substrates.

33. The target pattern of claim 32, wherein the substrate is a silicon wafer comprising a silicon dioxide layer.

34. The target pattern of claim 31, wherein the template layer is a quinone layer.

35. The target pattern of claim 34, wherein the first oxidation state is lower than the second oxidation state.

36. The target pattern of claim 35, wherein first oxidation state is hydroquinone and the second oxidation state is benzoquinone.

37. The target pattern of claim 35, wherein the template pattern comprises the second portion of the template layer having second oxidation state.

38. The target pattern of claim 31, wherein the first oxidation state is higher than the second oxidation state.

39. The target pattern of claim 38, wherein first oxidation state is benzoquinone and the second oxidation state is hydroquinone.

40. The target pattern of claim 38, wherein the template pattern comprises the first portion of the template layer having the first oxidation state.

41. The target pattern of claim 31, wherein the target material is selected from the group consisting of an oligonucleotide, DNA, a protein, a polymer, a dendrimer, a carbohydrate, an antibody, a nucleic acid, a nanoparticle, a quantum dot, and mixtures thereof.

42. The target pattern of claim 41, wherein the target material is an oligonucleotide having cyclopentadiene phosphoramidite conjugated to the 5′ end of the oligonucleotide.

43. The target pattern of claim 31, wherein the target material comprises a metal.

44. The target pattern of claim 43, wherein the metal is selected from the group consisting of Ag, Au, Pd, Pt, and mixtures thereof.

45. A kit for forming a target pattern, comprising:
at least one substrate comprising a template layer having a first oxidation state;
at least one redox agent adapted to be patterned on the template, wherein upon contact with the redox agent, the contacted portion of the template layer changes from the first oxidation state to the second oxidation state, different than the first oxidation state to form a template pattern, the template pattern being formed from the portion of the template layer having either the first oxidation state or the second oxidation state; and
instructions for forming the target pattern.

46. The kit of claim 45, further comprising a target material adapted to selectively bind to the template pattern to form the target pattern.

47. The kit of claim 45, further comprising at least one tip for patterning the redox agent on the template layer.

48. The kit of claim 47, wherein the tip is adapted for use in a patterning method selected from the group consisting of dip-pen nanolithography, polymer pen lithography, microcontact printing, and microfluidic patterning.


SEQUENCE LISTING (1 sequence)

SEQ ID NO: 1 - DNA, 31 bp, Artificial Sequence
  Synthetic oligonucleotide
ttttttttttttggaataacatgacctggat